(19) United States
(12) Patent Application Publication
(10) Pub. No.: US 2016/0352183 A1
(43) Pub. Date: Dec. 1, 2016

(54) ALTERNATOR UNIT HAVING VIBRATION REDUCING DAMPER

(71) Applicant: Hyundai Motor Company, Seoul (KR)

(72) Inventor: Wan Soo OH, Yongin-si (KR)

(73) Assignee: HYUNDAI MOTOR COMPANY, Seoul (KR)

(21) Appl. No.: 14/885,201

(22) Filed: Oct. 16, 2015

(30) Foreign Application Priority Data
May 26, 2015 (KR) 10-2015-0073255

(51) Int. Cl. H02K 5/24; F16F 15/129; H02K 7/10; F16F 15/123

(52) U.S. Cl. CPC H02K 5/24; F16F 15/123; F16F 15/12326; F16F 15/1232; F16F 15/129; H02K 7/1004; F16F 2232/02

(57) ABSTRACT

An alternator unit having a vibration reducing damper includes first rotating member, and second rotating member connected by a clutch member. A pulley is rotatably disposed on either the first rotating member or the second rotating member by a bearing and receives torque from outside. A first damper plate is fixed to one side of the pulley, and first spring grooves are radially spaced apart at a predetermined distance. A pair of second damper plates each have one side fixed to the second rotating member and are spaced apart from the first damper plate. The second damper plates have second spring grooves formed at positions corresponding to the first spring grooves. Damper springs are inserted into the first and second spring grooves, and transmit torque to the second damper plates and the second rotating member to absorb a rotational difference and attenuate vibration using compressive elastic force.

### CROSS-REFERENCE TO RELATED APPLICATIONS

This application claims the benefit of Korean Patent Application No. 10-2015-0073255, filed in the Korean Intellectual Property Office on May 26, 2015, the entire contents of which are incorporated herein by reference.

### FIELD

The present disclosure relates to an alternator unit that is operated using driving power transmitted through a belt from a crankshaft of an engine.

### BACKGROUND

The statements in this section merely provide background information related to the present disclosure and may not constitute prior art.

In general, a number of electrical devices including electrical components such as a device for starting an engine and an ignition system, lamps, and an air conditioning system are provided in a vehicle, and a battery and an alternator are provided as means for supplying electric power to the electrical devices.

More specifically, electric power required for the vehicle is produced by an alternator being operated by engine output, is stored in the battery, and is then distributed to respective necessary electrical systems such as the engine, lighting devices, instruments, warning display devices, and the air conditioning system as necessary, and the alternator supplements consumed electric power.

The alternator has a pulley mounted on a shaft connected with a rotor therein in order to be connected with a crankshaft of the engine by means of a belt, and produces electric power by rotating the shaft using the pulley being rotated by receiving driving power transmitted through the belt from the crankshaft.

Here, the alternator in the related art has a damper pulley in which an elastic member is mounted, thereby absorbing vibration transmitted from the belt using the elastic member and insulating vibration.

The damper pulley controls vibration absorbing performance by adjusting stiffness of the elastic member mounted in the damper pulley. However, in the case of the damper pulley in the related art, the stiffness of the elastic member mounted in the damper pulley is sometimes reduced in order to absorb vibration in an idle region with high dynamic displacement, but in a case in which stiffness of the elastic member is reduced, there are limitations in durability and performance such that a function of the damper pulley is lost, and as a result, there is a limitation in applying the elastic member with low stiffness.

In addition, because of the limitation in reducing stiffness of the elastic member, idle vibration cannot be efficiently absorbed in an overrun section of the vehicle, such that vibration being transmitted to the vehicle is increased, and overall marketability of the vehicle may deteriorate.

The above information disclosed in this Background section is only for enhancement of understanding of the background of the disclosure and therefore it may contain information that does not form the prior art that is already known in this country to a person of ordinary skill in the art.

### SUMMARY

Generally, the present disclosure provides an alternator unit which has a vibration reducing damper in order to reduce vibration or resonance that occurs between an alternator and a belt when an engine is operated.

According to one form of the present disclosure, an alternator unit having a vibration reducing damper is provided, the alternator unit including: an alternator which is disposed to produce electricity using torque input through a first rotating member; a second rotating member which is disposed coaxially with the first rotating member and connected to the first rotating member by means of a clutch member so that the second rotating member is rotated together with the first rotating member in one direction and separated from the first rotating member in the other direction; a pulley which is rotatably disposed on an outer surface of the first rotating member or the second rotating member by means of a bearing and receives torque from the outside; a first damper plate which has one side fixed to one side of the pulley, and first spring grooves formed to be spaced apart from a rotational center axis of the shaft at a predetermined distance; second damper plates which have one side fixed to an outer circumferential surface of the second rotating member, are disposed to be spaced apart from the first damper plate at a predetermined interval, and have second spring grooves formed at positions corresponding to the first spring grooves; and damper springs which are simultaneously inserted into the first spring grooves and the second spring grooves, and transmit torque, which is transmitted through the pulley and the first damper plate, to the second damper plates and the second rotating member to absorb a rotational difference and attenuate vibration using compressive elastic force.

The first rotating member may have a pipe structure into which an end of an input shaft of the alternator is fixedly inserted, and the second rotating member may be disposed coaxially with the first rotating member.

The clutch member may be a coil type of spring clutch which is wound around outer circumferential surfaces of the first rotating member and the second rotating member so that an inner circumferential surface at one side of the coil type spring clutch is in elastically close contact with the outer circumferential surface of the first rotating member, and an inner circumferential surface at the other side of the coil type spring clutch is in elastically close contact with the outer circumferential surface of the second rotating member.

The second damper plates may be disposed at an interval in a longitudinal direction of the second rotating member, and the first damper plate may be disposed between the second damper plates.

Friction plates, which produce frictional force between the first damper plate and the second damper plates, may be interposed between the first damper plate and the second damper plates.

Connecting pins, which penetrate the second damper plates and the first damper plate and provide coupling force between the second damper plates and the first damper plate, may be fastened.

The first rotating member and the second rotating member may penetrate a rotational center of the pulley, the pulley may be rotatably fastened between the first rotating member and the second rotating member by means of a bearing, and a belt may be in close contact with one side of an outer circumferential surface of the pulley.

The alternator unit may further include a connecting member which is fixed to one side of the pulley, extends in a longitudinal direction of the second rotating member, and has an inner circumferential surface to which an end of the first damper plate is fixed.

The alternator unit may further include a cap which engages with the connecting member in order to cover the damper springs and the second damper plates.

The first damper plate and the second damper plates may have a ring shape disposed along an outer circumference of the second rotating member, and the damper springs may be disposed at a predetermined interval in a rotational direction of the second rotating member.

Another form of the present disclosure provides an alternator unit having a vibration reducing damper, the alternator unit including: an alternator which is disposed to produce electricity using torque input through a shaft; a second rotating member which is disposed coaxially with the shaft and connected to the shaft by means of a clutch member so that the second rotating member is rotated together with the shaft in one direction and separated from the shaft in the other direction; a pulley which is rotatably disposed on an outer surface of the shaft or the second rotating member by means of a bearing and receives torque from the outside; a first damper plate which has one side fixed to one side of the pulley, and first spring grooves formed to be spaced apart from a rotational center axis of the shaft at a predetermined distance; second damper plates which have one side fixed to an outer circumferential surface of the second rotating member, are disposed to be spaced apart from the first damper plate at a predetermined interval, and have second spring grooves formed at positions corresponding to the first spring grooves; and damper springs which are simultaneously inserted into the first spring grooves and the second spring grooves, and transmit torque, which is transmitted through the pulley and the first damper plate, to the second damper plates and the second rotating member to absorb a rotational difference and attenuate vibration using compressive elastic force.

The clutch member may be a bearing type of one-way clutch which has an inner circumferential surface in close contact with an outer circumferential surface of the shaft, and an outer circumferential surface in elastically close contact with an inner circumferential surface of the second rotating member.

The shaft and the second rotating member may penetrate a rotational center of the pulley, the pulley may be rotatably fastened between the shaft and the second rotating member by means of a bearing, and a belt may be in close contact with one side of an outer circumferential surface of the pulley.

The second rotating member may have a pipe structure, the shaft may be inserted into a central portion of the second rotating member, and the clutch member may be interposed between an inner circumferential surface of the second rotating member and an outer circumferential surface of the shaft.

Yet another form the present disclosure provides an engine including the alternator unit.

Still another form the present disclosure provides a vehicle including the alternator unit.

According to the present disclosure, rotational differences between the pulley and the alternator may be intermittently controlled by the one-way clutch or the spring clutch, and it is possible to reduce vibration or resonance, which occurs at the alternator, the pulley, and the belt by installing a spring damper structure between the alternator and the pulley.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic cross-sectional view of an alternator unit having a vibration reducing damper according to one form of the present disclosure;

FIG. 2 is a schematic cross-sectional view of the alternator unit having the vibration reducing damper according to one form of the present disclosure;

FIG. 3 is a partially exploded perspective view of the alternator unit having the vibration reducing damper according to one form of the present disclosure; and

FIG. 4 is a graph showing an effect of the alternator unit having the vibration reducing damper according to one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

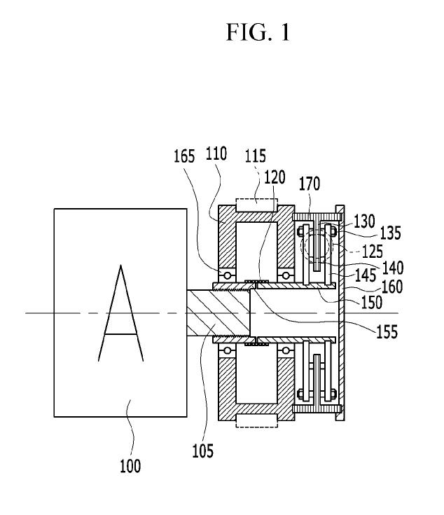

FIG. 1 is a schematic cross-sectional view of an alternator unit having a vibration reducing damper according to one form of the present disclosure.

Referring to FIG. 1, the alternator unit includes an alternator 100, a shaft 105, a first rotating member 155, a second rotating member 150, a cap 160, second damper plates 145, friction plates 140, damper springs 125, connecting pins 135, a first damper plate 130, a connecting member 170, a spring clutch 120, a belt 115, and a pulley 110.

The shaft 105 extends toward the outside from a rotation center of the alternator 100 to input torque to the alternator 100, and the alternator 100 produces an electric current using torque input through the shaft 105 and is connected to a separate battery (not illustrated) and an engine (not illustrated).

The alternator 100 may charge the battery provided in a vehicle or the engine, and supply electrical power directly to electrical components.

The first rotating member 155 and the second rotating member 150 have a pipe structure and are arranged coaxially with the shaft 105, and an end of the shaft 105 is inserted into the first rotating member 155.

The first rotating member 155 and the second rotating member 150 are disposed coaxially with each other at an interval, and the spring clutch 120 engages with the first and second rotating members 155 and 150.

That is, the spring clutch 120 is in slidably close contact with an outer circumferential surface of the first rotating member 155 and an outer circumferential surface of the second rotating member 150, and the second rotating member 150 rotates the first rotating member 155 in a direction in which a coil of the spring clutch 120 is wound, but the first rotating member 155 cannot rotate the second rotating member 150 but spins without traction.

In one form of the present disclosure, when torque is transmitted through the pulley 110, the first and second rotating members 155 and 150 are rotated together, and when the shaft 105 of the alternator 100 is rotated, the spring clutch 120 cuts off transmission of torque between the first and second rotating members 155 and 150.

The first rotating member 155 and the second rotating member 150 penetrate the rotation center of the pulley 110, and the pulley 110 is rotatably connected with the first and second rotating members 155 and 150 by means of a bearing 165.

The connecting member 170 is fixed to one side of the pulley 110, and the connecting member 170 extends in a longitudinal direction of the second rotating member 150 and extends in a rotational direction of the second rotating member 150.

In addition, the first damper plate 130 is integrally connected to a central portion of an inner circumferential surface of the connecting member 170, and the first damper plate 130 extends in a direction of the rotation center of the second rotating member 150. Therefore, the pulley 110, the connecting member 170, and the first damper plate 130 are rotated together.

Second damper plates 145 are disposed at a predetermined distance at both sides of the first damper plate 130. One end of each of the second damper plates 145 engages with the second rotating member 150 so that the second damper plates 145 are rotated together with the second rotating member 150, and the second damper plates 145 are coupled to the second rotating member 150 by means of a splined structure so as to be movable in a longitudinal direction of the second rotating member 150.

The friction plates 140 are disposed between the first damper plate 130 and the second damper plates 145, respectively, and the connecting pins 135 penetrate the second damper plates 145 and the first damper plate 130 and provide coupling force between the second damper plates 145 and the first damper plate 130.

The connecting pins 135 substantially provide force so that predetermined frictional force is produced by the friction plates 140 interposed between the second damper plates 145 and the first damper plate 130.

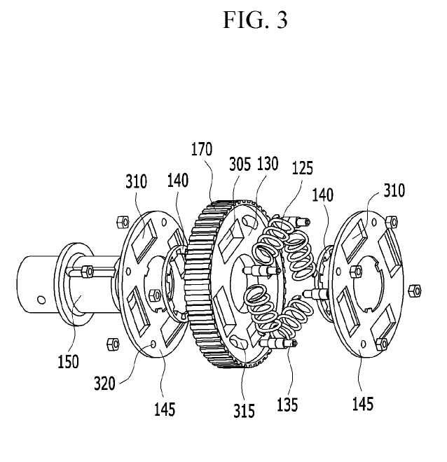

Referring to FIG. 3, first spring grooves 305 and second spring grooves 310 are formed in the first damper plate 130 and the second damper plates 145, respectively, and the damper springs 125 are simultaneously inserted into the first spring grooves 305 and the second spring grooves 310.

In addition, the connecting pins 135 are inserted into connecting pin insertion holes 320 in the second damper plate 145, and the connecting pins 135 are rotated in rotational difference absorbing slots 315 in the first damper plates 130. When the damper springs 125 are removed, a rotational difference may occur between the first and second damper springs 125 of as much as the length of the rotational difference absorbing slots 315.

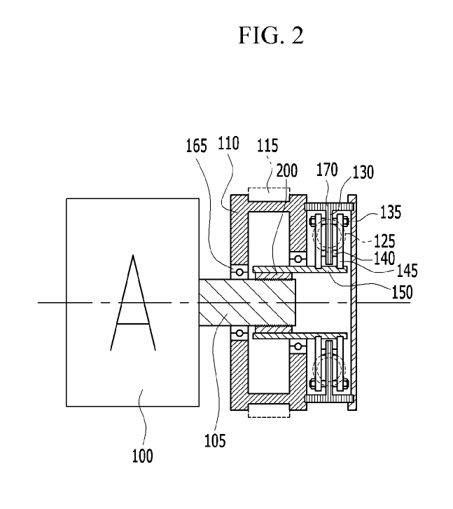

FIG. 2 is a schematic cross-sectional view of the alternator unit having the vibration reducing damper according to one form of the present disclosure.

Referring to FIG. 2, the alternator unit includes the alternator 100, the shaft 105, the second rotating member 150, the cap 160, the second damper plates 145, the friction plates 140, the damper springs 125, the connecting pins 135, the first damper plate 130, the connecting member 170, a one-way clutch 200, the belt 115, and the pulley 110.

The shaft 105 is connected with the alternator 100 to input torque to the alternator 100, and the alternator 100 may produce an electric current using torque input through the shaft 105.

The second rotating member 150 has a pipe structure and is disposed coaxially with the shaft 105, and an end of the shaft 105 is inserted into the second rotating member 150.

The one-way clutch 200 is in close contact with an outer circumferential surface of the shaft 105 and an inner circumferential surface of the second rotating member 150, the second rotating member 150 rotates the shaft 105, but the shaft 105 cannot rotate the second rotating member 150 due to the one-way clutch 200 and spins without traction.

In the one form of the present disclosure, when torque is transmitted through the pulley 110, the shaft 105 and the second rotating member 150 are rotated together, and when the shaft 105 of the alternator 100 is rotated more quickly, the one-way clutch 200 cuts off transmission of torque between the shaft 105 and the second rotating member 150.

The shaft 105 and the second rotating member 150 penetrate the rotation center of the pulley 110, and the pulley 110 is freely and rotatably connected with the shaft 105 and the second rotating member 150 by means of the bearing 165.

The connecting member 170 is fixed to one side of the pulley 110, and the connecting member 170 extends in the longitudinal direction of the second rotating member 150 and extends in the rotational direction of the second rotating member 150.

In addition, the first damper plate 130 is integrally connected to the central portion of the inner circumferential surface of the connecting member 170, and the first damper plate 130 extends in a direction of the rotation center of the second rotating member 150. Therefore, the pulley 110, the connecting member 170, and the first damper plate 130 are rotated together.

The second damper plates 145 are disposed at a predetermined distance at both sides of the first damper plate 130. One end of each of the second damper plates 145 engages with the second rotating member 150 so that the second damper plates 145 are rotated together with the second rotating member 150, and the second damper plates 145 are coupled to the second rotating member 150 by means of a splined structure so as to be movable in the longitudinal direction of the second rotating member 150.

The friction plates 140 are disposed between the first damper plate 130 and the second damper plates 145, respectively, and the connecting pins 135 penetrate the second damper plates 145 and the first damper plate 130 and provide coupling force between the second damper plates 145 and the first damper plate 130.

FIG. 3 is a partially exploded perspective view of the alternator unit having the vibration reducing damper according to the one form of the present disclosure, and FIG. 3 does not illustrate the pulley and the belt, but schematically illustrates only some components.

Referring to FIG. 3, the second damper plates 145 have a disk shape, and the second rotating member 150 penetrates central portions of the second damper plates 145 and is coupled to the second damper plates 145 in a splined manner, such that the second rotating member 150 is rotated together with the second damper plates 145. In addition, the second damper plates 145 are movable in the longitudinal direction of the second rotating member 150.

The first spring grooves 305 are formed in the first damper plate 130, the second spring grooves 310 are formed in the second damper plates 145 corresponding to the first spring grooves 305, and the damper springs 125 are simultaneously inserted into the first and second spring grooves 305 and 310.

Therefore, torque being transmitted to the first damper plate 130 is transmitted to the damper spring 125 and the second damper spring 125, and the damper spring 125 absorbs vibration and noise.

The second damper plate 145 has the connecting pin insertion holes 320 into which the connecting pins 135 are inserted, and the first damper plate 130 has the rotational difference absorbing slots 315 into which the connecting pins 135 are inserted, such that the first damper plate 130 has a rotational difference with respect to the second damper plates 145.

The friction plates 140 have a flat spring structure having a ring shape, and produce predetermined frictional force between the first and second damper plates 130 and 145, thereby absorbing vibration and noise.

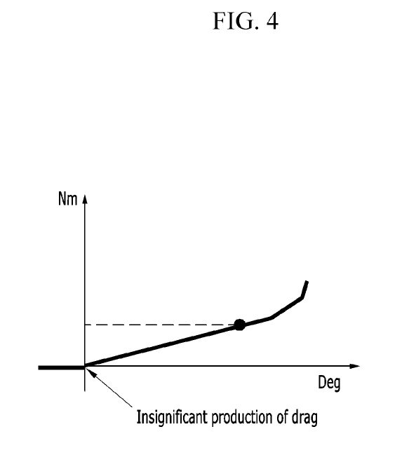

FIG. 4 is a graph showing an effect of the alternator unit having the vibration reducing damper according to the one form of the present disclosure.

Referring to FIG. 4, the horizontal axis represents a rotational speed, and the vertical axis represents overall drag (frictional force).

In a case in which the pulley 110 is rotated by the belt 115, drag is produced to charge the alternator 100, but in a case in which the shaft 105 of the alternator 100 is rotated, the one-way clutch 200 or the spring clutch 120 cuts off torque, and as a result, drag is hardly produced.

In addition, the damper springs 125 and the friction plates 140 absorb vibration and noise, such that drag is constantly produced.

The present disclosure described above may be variously substituted, altered, and modified by those skilled in the art to which the present disclosure pertains without departing from the scope and sprit of the present disclosure. Therefore, the present disclosure is not limited to the above-mentioned forms and the accompanying drawings.

What is claimed is:

1. An alternator unit having a vibration reducing damper, the alternator unit comprising:
an alternator which is disposed to produce electricity using torque input through a first rotating member;
a second rotating member which is disposed coaxially with the first rotating member and connected to the first rotating member by means of a clutch member so that the second rotating member is rotated together with the first rotating member in one direction and separated from the first rotating member in the other direction;
a pulley which is rotatably disposed on an outer surface of the first rotating member or the second rotating member by means of a bearing and receives torque from outside the pulley;
a first damper plate which has one side fixed to one side of the pulley, and first spring grooves formed to be radially spaced apart from a rotation center axis of the shaft at a predetermined distance;
second damper plates which have one side fixed to an outer circumferential surface of the second rotating member, are disposed to be spaced apart from the first damper plate at a predetermined interval, and have second spring grooves formed at positions corresponding to the first spring grooves; and
damper springs which are simultaneously inserted into the first spring grooves and the second spring grooves, and transmit torque, which is transmitted through the pulley and the first damper plate, to the second damper plates and the second rotating member to absorb a rotational difference and attenuate vibration using compressive elastic force.

2. The alternator unit of claim 1, wherein
the first rotating member has a pipe structure into which an end of an input shaft of the alternator is fixedly inserted, and
the second rotating member is disposed coaxially with the first rotating member.

3. The alternator unit of claim 1, wherein
the clutch member is
a coil type of spring clutch which is wound around outer circumferential surfaces of the first rotating member and the second rotating member so that an inner circumferential surface at one side of the coil type spring clutch is in elastically close contact with the outer circumferential surface of the first rotating member, and an inner circumferential surface at the other side of the coil type spring clutch is in elastically close contact with the outer circumferential surface of the second rotating member.

4. The alternator unit of claim 1, wherein
the second damper plates are disposed at an interval in a longitudinal direction of the second rotating member, and the first damper plate is disposed between the second damper plates.

5. The alternator unit of claim 4, wherein
friction plates, which produce frictional force between the first damper plate and the second damper plates, are interposed between the first damper plate and the second damper plates.

6. The alternator unit of claim 4, wherein
connecting pins, which penetrate the second damper plates and the first damper plate and provide coupling force between the second damper plates and the first damper plate, are fastened.

7. The alternator unit of claim 1, wherein
the first rotating member and the second rotating member penetrate a rotation center of the pulley, the pulley is rotatably fastened between the first rotating member and the second rotating member by means of a bearing, and a belt is in close contact with one side of an outer circumferential surface of the pulley.

8. The alternator unit of claim 1, further comprising
a connecting member which is fixed to one side of the pulley, extends in a longitudinal direction of the second rotating member, and has an inner circumferential surface to which an end of the first damper plate is fixed.

9. The alternator unit of claim 8, further comprising
a cap which engages with the connecting member so as to cover the damper springs and the second damper plates.

10. The alternator unit of claim 1, wherein
the first damper plate and the second damper plates have a ring shape disposed along an outer circumference of the second rotating member, and the damper springs are disposed at a predetermined interval in a rotational direction of the second rotating member.

11. An alternator unit having a vibration reducing damper, the alternator unit comprising:
an alternator which is disposed to produce electricity using torque input through a shaft;
a second rotating member which is disposed coaxially with the shaft and connected to the shaft by means of a clutch member so that the second rotating member is rotated together with the shaft in one direction and separated from the shaft in the other direction;
a pulley which is rotatably disposed on an outer surface of the shaft or the second rotating member by means of a bearing and receives torque from outside the pulley;
a first damper plate which has one side fixed to one side of the pulley, and first spring grooves formed to be radially spaced apart from a rotation center axis of the shaft at a predetermined distance;
second damper plates which have one side fixed to an outer circumferential surface of the second rotating member, are disposed to be spaced apart from the first damper plate at a predetermined interval, and have second spring grooves formed at positions corresponding to the first spring grooves; and
damper springs which are simultaneously inserted into the first spring grooves and the second spring grooves, and transmit torque, which is transmitted through the pulley and the first damper plate, to the second damper plates and the second rotating member to absorb a rotational difference and attenuate vibration using compressive elastic force.

12. The alternator unit of claim 11, wherein
the clutch member is
a bearing type of one-way clutch which has an inner circumferential surface in close contact with an outer circumferential surface of the shaft, and an outer circumferential surface in elastically close contact with an inner circumferential surface of the second rotating member.

13. The alternator unit of claim 11, wherein
the shaft and the second rotating member penetrate a rotation center of the pulley, the pulley is rotatably fastened between the shaft and the second rotating member by means of a bearing, and a belt is in close contact with one side of an outer circumferential surface of the pulley.

14. The alternator unit of claim 11, wherein
the second rotating member has a pipe structure, the shaft is inserted into a central portion of the second rotating member, and the clutch member is interposed between an inner circumferential surface of the second rotating member and an outer circumferential surface of the shaft.

15. An engine comprising the alternator unit according to claim 1.

16. A vehicle comprising the alternator unit according to claim 1.
